(19) United States
(12) Patent Application Publication
(10) Pub. No.: US 2006/0141364 A1
(43) Pub. Date: Jun. 29, 2006

(54) Electrolyte additive

(76) Inventor: Christine Ruth Jarvis, Oxfordshire (GB)

Correspondence Address: LAW OFFICES OF WILLIAM H. HOLT, 12311 HARBOR DRIVE, WOODBRIDGE, VA, 22192, US

(21) Appl. No.: 10/543,411

(22) PCT Filed: Jan. 16, 2004
(86) PCT No.: PCT/GB04/00153

§ 371 Date: Jul. 26, 2005

(30) Foreign Application Priority Data
Feb. 6, 2003 (GB) 0302689.5

(51) Int. Cl. H01M 10/40

(52) U.S. Cl. 429/338; 429/330

(57) ABSTRACT

An electrolyte for use in a lithium ion cell that has a tin anode, the electrolyte comprising vinyl ethylene carbonate.

This invention relates to an electrolyte for a lithium ion cell in which the anode comprises tin, and to lithium ion cells containing such an electrolyte.

For many years it has been known to make cells with lithium metal anodes, and cathodes of a material into which lithium ions can be intercalated or inserted. A wide variety of intercalation or insertion materials are known as cathode materials for rechargeable lithium cells, such as TiS₂ or V₆O₁₃. To avoid the problems arising from dendrite growth at lithium metal anodes during cycling it has been proposed to use an intercalation material such as carbon as the anode material. In this case the cathode material will be generally an intercalation material that initially contains lithium ions, such as LiₓCoO₂ where x is less than 1. Rechargeable cells of this type, in which both the anode and cathode contain intercalated lithium ions, are now available commercially, and may be referred to as lithium ion cells, or as swing or rocking-chair cells. Several different carbonaceous materials such as coke, graphite or carbon fibre have been suggested for use in anodes. Graphite is commonly used commercially, but the capacity of this material in commercial cells is close to the theoretical limit for LiC₆ (372 mA h/g). Alternative anode materials have therefore been suggested in order to increase electrode capacity, and in this respect tin electrodes have the benefit of a markedly higher theoretical capacity: 994 mA h/g for Li_{4.4}Sn. However, during insertion of lithium ions, very large volume changes occur, which lead to breakup of the electrode material and so poor cycle performance.

Annealing a tin electrode before use so as to form, for example, a tin-copper alloy has been found to improve the cycle performance of the cell. However, such electrodes still have lower cycle efficiencies than are required for long cycle life Li-ion cells.

The present invention aims to address this problem of poor cycle performance for cells with tin anodes.

Accordingly, the present invention provides an electrolyte for use in a lithium ion cell comprising a tin anode, the electrolyte comprising vinyl ethylene carbonate.

The present invention also provides a lithium ion cell with a tin anode wherein the electrolyte comprises vinyl ethylene carbonate.

Typically the electrolyte comprises from 0.5 to 20 volume % of vinyl ethylene carbonate, preferably from 1 to 10 volume % and most preferably about 5 volume %.

The electrolyte may also comprise ethylene carbonate, propylene carbonate, diethyl carbonate, dimethyl carbonate or mixtures thereof. In a preferred embodiment the electrolyte comprises ethylene carbonate and/or propylene carbonate.

The electrolyte must also contain lithium ions and so comprises a lithium salt such as LiPF₆, LiBF₄, lithium imide (LiN(CF₃SO₂)₂ or lithium bis-(trifluoromethanesulphonyl) imide) or lithium methide (LiC(SO₂CF₃) 3, lithium tris-(trifluoromethanesulphonyl) methide.

In a preferred embodiment, the electrolyte comprises vinyl ethylene carbonate, ethylene carbonate, propylene carbonate and a lithium salt.

The invention also provides a process for making a lithium ion cell with a tin anode which process comprises: making an anode comprising a layer of tin; assembling a cell comprising the said anode, a cathode comprising lithium ions, and an electrolyte comprising lithium ions and vinyl ethylene carbonate.

The cathode is made of a material containing intercalated lithium ions. For example, a lithium cobalt oxide, a lithium nickel oxide, a lithium nickel cobalt oxide such as LiNi₁₋ₓCoₓO₂ or a lithium manganese oxide such as LiMn₂O₄.

The present invention also provides the use of an electrolyte comprising vinyl ethylene carbonate and a lithium salt in a lithium ion cell comprising a tin anode.

The invention will now be further described by way of example only, and with reference to the accompanying drawing which shows a graph of efficiency against cycle number for the test cells described in Example 1 and Comparative Example 1.

### EXAMPLE 1

Test cells containing a tin anode were made containing an electrolyte consisting of ethylene carbonate, propylene carbonate, 1 molar LiPF₆ and vinyl ethylene carbonate. The ratio of ethylene carbonate to propylene carbonate was 2:1 by volume. The ethylene and propylene carbonates were mixed in a 2:1 ratio and then vinyl ethylene carbonate was added to form 5 volume % of the final mixture. LiPF₆ was added to the mixture of liquids to form a 1 molar solution. The test cells contained three electrodes: a LiCoO₂ counter electrode and a lithium reference electrode as well as the tin anode.

The tin electrode was cycled with respect to the lithium reference electrode between voltage limits of 0.01 V and 2.00 V at a constant current.

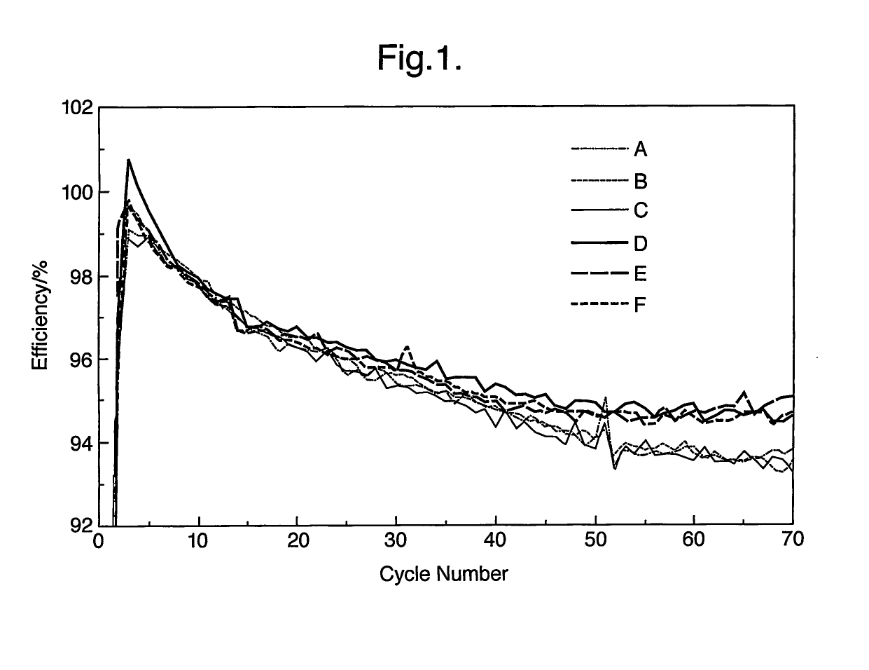

The cycle efficiencies of the three cells (D, E and F) are shown in FIG. 1.

### COMPARATIVE EXAMPLE 1

Test cells were made as described in Example 1 containing an electrolyte consisting of a 2:1 ratio of ethylene carbonate to propylene carbonate to which was added LiPF₆ to form a 1 molar solution.

These test cells were cycled between voltage limits as described in Example 1 and the cycle efficiencies of the three cells (A, B and C) are shown in FIG. 1.

From FIG. 1 it can be seen that an increased cycle efficiency is shown by the cells where the electrolyte comprises vinyl ethylene carbonate. Thus a tin anode lithium ion cell where the electrolyte comprises vinyl ethylene carbonate will last for a greater number of cycles than a cell without vinyl ethylene carbonate.

1. An electrolyte for use in a lithium ion cell comprising a tin anode, the electrolyte comprising vinyl ethylene carbonate.

2. An electrolyte according to claim 1 wherein the electrolyte comprises from 0.5 to 20 volume % of vinyl ethylene carbonate.

3. An electrolyte according to claim 2 wherein the electrolyte comprises 5 volume % of vinyl ethylene carbonate.

4. An electrolyte according to claim 1 wherein the electrolyte further comprises ethylene carbonate and propylene carbonate.

5. A lithium ion cell with a tin anode wherein the electrolyte comprises vinyl ethylene carbonate.

6. A cell according to claim 5 wherein the electrolyte comprises from 0.5 to 20 volume % of vinyl ethylene carbonate.
